(19) United States
(12) Patent Application Publication
(10) Pub. No.: US 2022/0156572 A1
(43) Pub. Date: May 19, 2022

(54) DATA PARTITIONING WITH NEURAL NETWORK

(71) Applicant: International Business Machines Corporation, Armonk, NY (US)

(72) Inventors: Si Er Han, Xi'an (CN); Jing Xu, Xi'an (CN); Xue Ying Zhang, Xi'an (CN); Ji Hui Yang, Beijing (CN); Steven George Barbee, Amenia, NY (US)

(21) Appl. No.: 16/950,017

(22) Filed: Nov. 17, 2020

(51) Int. Cl. G06N 3/08; G06F 16/27

(52) U.S. Cl. CPC G06N 3/08; G06F 16/278

(57) ABSTRACT

A computer-implemented method, system and computer program product for processing a data set is provided. In this method, an original data set including a plurality of data records is obtained. Each data record in the original data set has values of a first number of features. A representative data set having the plurality of representative data records is determined. Each representative data record has values of a second number of representatives. The second number of representatives are obtained by training an autoencoder neutral network with values of the first number of features as inputs, and the second number is smaller than the first number. The plurality of representative data records is segmented into two or more clusters based on the values of the second number of representatives. The representative data records in the two or more clusters are partitioned to form a predefined number of representative data subsets.

### BACKGROUND

The disclosure relates generally to machine learning, and more specifically to methods, systems and computer program products for data partitioning with neural network

Machine learning is the science of getting computers to act without being explicitly programmed. In other words, machine learning is a method of data analysis that automates analytical model building. Machine learning is a branch of artificial intelligence based on the idea that computer systems can learn from data, identify patterns, and make decisions with minimal human intervention.

The majority of machine learning uses supervised learning. Supervised learning is the task of learning a function that maps an input to an output based on example input-output pairs. Supervised learning infers a function from labeled training data consisting of a set of training examples. Each example is a pair consisting of an input object, which is typically a vector, and a desired output value (e.g., a supervisory signal).

A supervised learning algorithm analyzes the training data and produces an inferred function, which can be used for mapping new examples. An optimal scenario allows the supervised learning algorithm to correctly determine the class labels for unseen data. This requires the supervised learning algorithm to generalize from the training data to unseen data in a “reasonable” way (e.g., inductive bias).

The term supervised learning comes from the idea that the algorithm is learning from a training data set, which can be thought of as a teacher. The algorithm iteratively makes predictions on the training data set and is corrected by the teacher. Learning stops when the algorithm achieves an acceptable level of performance.

### SUMMARY

According to one illustrative embodiment, a computer-implemented method for processing a data set is provided. In this method, an original data set including a plurality of data records is obtained. Each data record in the original data set has values of a first number of features. A representative data set having the plurality of representative data records is determined. Each representative data record has values of a second number of representatives. The second number of representatives are obtained by training an autoencoder neutral network with values of the first number of features as inputs, and the second number is smaller than the first number. The plurality of representative data records are segmented into two or more clusters based on the values of the second number of representatives. The representative data records in the two or more clusters are partitioned to form a predefined number of representative data subsets. In other embodiments, a system and a computer program product are disclosed.

Other embodiments and aspects, including but not limited to, computer systems and computer program products, are described in detail herein and are considered a part of the claimed invention.

These and other features and advantages of the present invention will be described, or will become apparent to those of ordinary skill in the art in view of, the following detailed description of the example embodiments of the present invention.

### BRIEF DESCRIPTION OF THE DRAWINGS

FIG. 1 depicts a cloud computing node according to an embodiment of the present invention;

FIG. 2 depicts a cloud computing environment, in accordance with an embodiment of the present invention;

FIG. 3 depicts abstraction model layers, in accordance with an embodiment of the present invention;

FIG. 4 is a flowchart illustrating a process for data partition, in accordance with an embodiment of the present invention;

FIG. 5 is a diagram illustrating an example autoencoder neural network, in accordance with an embodiment of the present invention;

FIG. 6A is a diagram illustrating an example of an original data set, in accordance with an embodiment of the present invention;

FIG. 6B is a diagram illustrating an example of a feature representative data set, in accordance with an embodiment of the present invention;

FIG. 6C is a diagram illustrating an example of a feature representative data set, in accordance with an embodiment of the present invention;

FIG. 6D is a diagram illustrating an example of a feature representative data set with data partition, in accordance with an embodiment of the present invention;

FIG. 6E is a diagram illustrating an example of an original data set with data partition, in accordance with an embodiment of the present invention;

FIG. 7 is a flowchart illustrating a process for evaluating data partition quality, in accordance with an embodiment of the present invention; and

FIG. 8 is a diagram illustrating an example for computing influential weight using an autoencoder neural network, in accordance with an embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

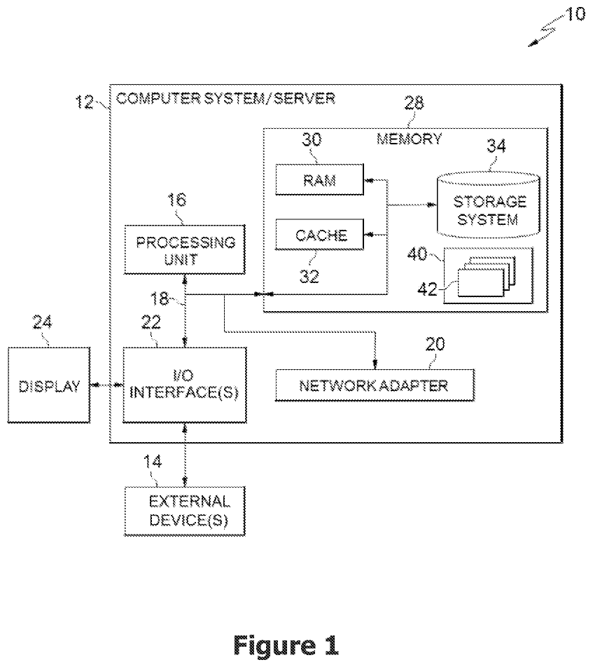

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

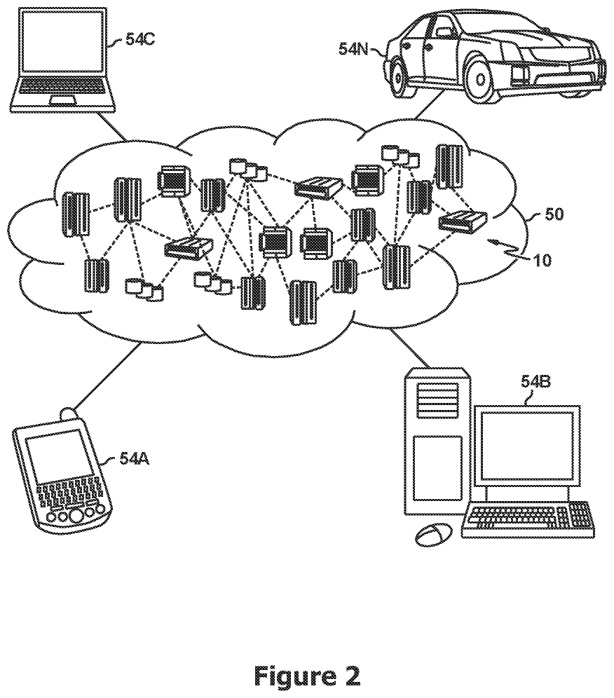

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

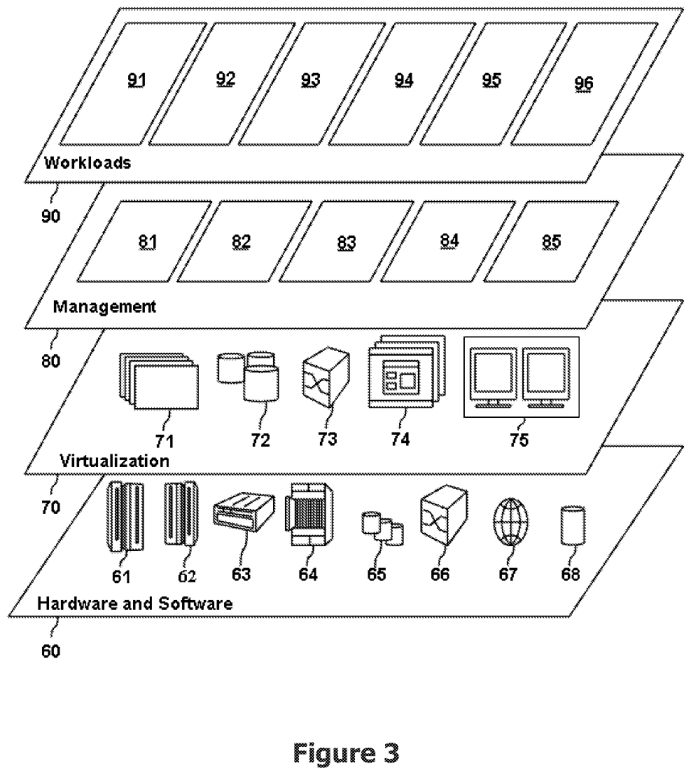

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

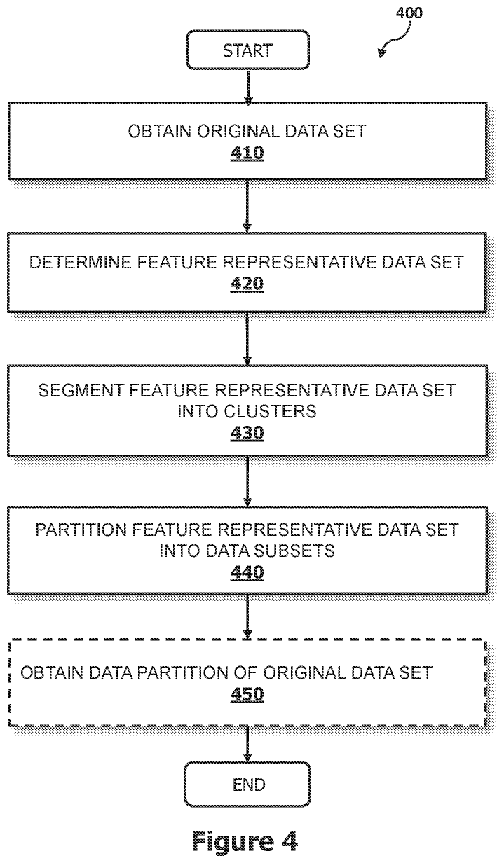

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data partitioning 96. Hereinafter, reference will be made to FIGS. 4-8 to describe details of the data partitioning 96.

In machine learning, supervised models are usually fitted on a historical or original data set consisting of input (i.e., predictor) data and output (i.e., target) data. Then, the supervised models are applied to new input data to predict the output. During this process, the historical data set is often randomly partitioned into subsets, such as, for example, a training data subset, a validation data subset, and a testing data subset. The training data subset is used to build the supervised machine learning model. The validation data subset is used to fine-tune hyper-parameters of the supervised machine learning model or select the best supervised machine learning model for supervised learning.

Once the final supervised machine learning model is built, the performance of the supervised machine learning model is evaluated on the testing data subset, which is not used during the building of the supervised machine learning model. If a data analyst does not want to fine-tune hyper-parameters or to select the supervised building model, then the validation data subset is not needed, and the historical data set is just partitioned into training data and testing data subsets.

Currently, most machine learning software performs data partitioning using random sampling methods based on a specified percentage of training, validation, and testing data subsets. However, deficiencies exist in random sampling methods. For example, random sampling methods fail to provide similar variable distribution as the historical data set.

For imbalanced data, to ensure that the class distribution in each data subset is the same as in the whole historical data set (i.e., distribution consistency), stratified sampling methods can be used. However, deficiencies also exist in stratified sampling methods. For example, stratified sampling is complicated and inefficient when a large number of categorical variables exist because stratified sampling needs to find all possible combinations of categories, and then perform the sampling in each combination. For continuous variables with skewed distribution, stratified sampling cannot ensure that the distribution of each data subset is the same as the whole historical data set. As a result, it is difficult for a user to build a high-quality supervised machine learning model using current sampling methods, even if the user spends a lot of time refining the model.

According to embodiments of the present invention, illustrative embodiments provide data partitioning that ensures feature/variable distribution of each data subset of a particular data partition of the historical data set is similar (i.e., as close as possible) to that of the historical data set (i.e., to provide variable distribution consistency). Illustrative embodiments also provide measures of validity for data partition, leading to recommendations as to whether a data partition can be used directly to build a supervised machine learning model or whether more data should be collected to increase the quality of the partitions.

When illustrative embodiments process an original data set, illustrative embodiments use autoencoder neural network to reduce the size of features of the data set, which can capture the non-linear combinations of original features. Clustering techniques are then used to segment records of feature representative into clusters. The feature representative data records are further partitioned into data subsets by stratified data sampling with the cluster label variable as stratified variable. A distribution similarity measure is defined to evaluate the quality of data partition. Partition label in feature representative data set are then merged to the original data set to obtain final data partition.

Illustrative embodiments are capable of working with categorical variables and continuous variables. Further, illustrative embodiments provide quality measure for the data partition, which may assist users in understanding whether a particular data partition can be used directly to build a supervised machine learning model corresponding to the historical data set or whether more data should be collected to increase quality of data partitions. Illustrative embodiments are capable of increasing performance of data partition, which enables the supervised machine learning model to predict unseen data more effectively.

Therefore, illustrative embodiments provide one or more technical solutions that overcome a technical problem with building an effective supervised machine learning model corresponding to a particular data set. As a result, these one or more technical solutions provide a technical effect and practical application in the field of supervised machine learning model building.

With reference now to FIG. 4, a flowchart illustrating a process for data partition is shown in accordance with an illustrative embodiment. The process shown in FIG. 4 may be implemented in a computer, such as, for example, computer system/server 12 in FIG. 1.

In step 410, the computer obtains an original data set. The original data set may include a plurality of data records, and each data record in the data set may have values of a first number of features (for example, n features, in which n is an integer). The features, also called variables here, may be different variables in the original data set and have different values for the data records. The original data set may represent an original body of information corresponding to particular entity, such as, for example, companies, businesses, enterprises, organizations, institutions, agencies, and the like. Each original data set may be related to a particular domain, such as, for example, an insurance domain, a banking domain, a healthcare domain, a financial domain, an entertainment domain, a business domain, or the like. For example, the original data set may be related to an insurance domain, and the data record in the original data set may be a data record corresponding to an individual. The features in the data set may include some basic information of the individual such as age, gender, height, weight, etc. The features in the data set may further include insurance related information such as the type of insurance, insurance premium, coverage, etc. For different individuals (data records), the feature would have different values. In another example, the original data set may be related to a banking domain, and the data record in the original data set may be a data record corresponding to a company. The features in the data set may include some information such as size of the company, business type, amount of loan to the company, its credit rating, etc. For different companies (data records), the feature would have different values.

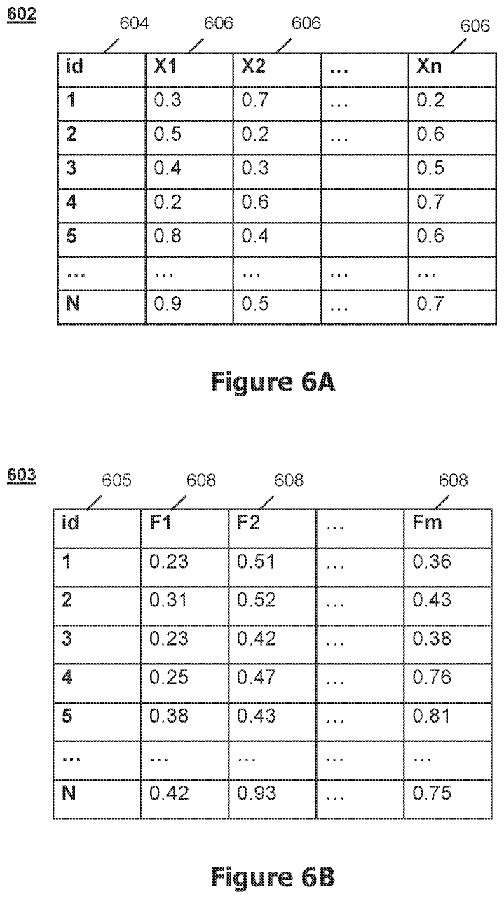

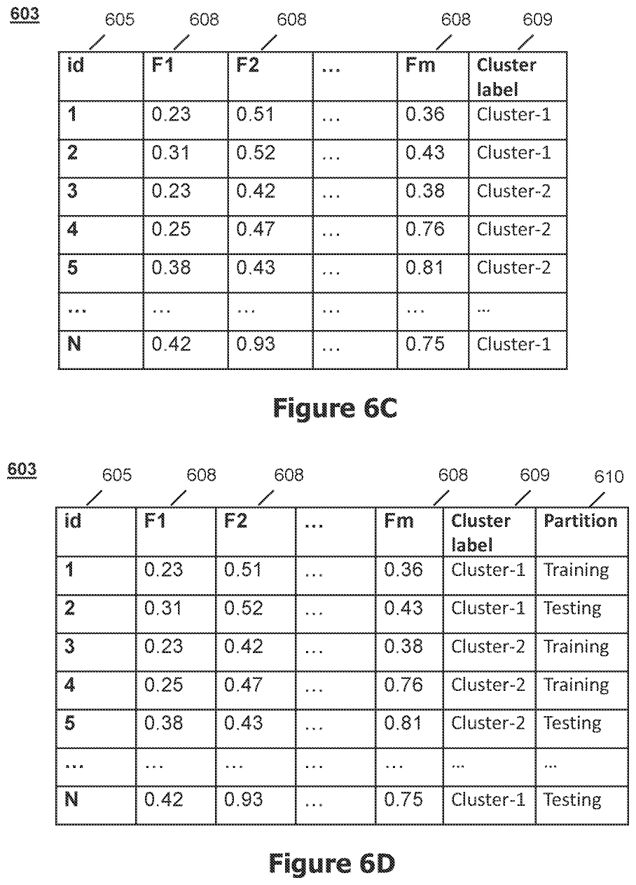

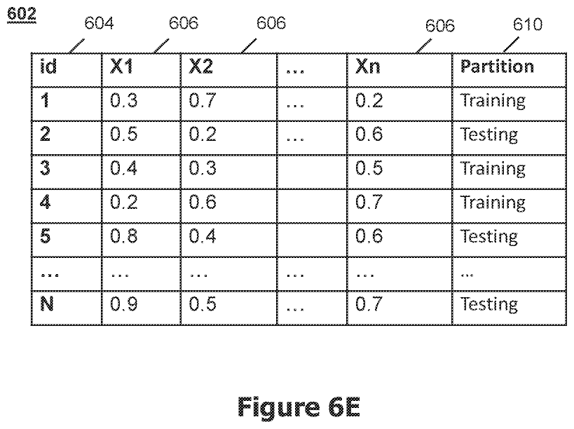

FIG. 6A depicts a diagram illustrating an example of an original data set in accordance with an illustrative embodiment of the present invention. Original data set 602 includes record ID 604 and features 606. Features 606 may represent any variables corresponding to the entity that owns original data set 602. It should be noted that each column in the table is one feature, such as X1, X2, X3, . . . Xn. In addition, features 606 may be categorical variables or continuous variables.

Record ID 604 may represent a data record in the original data set 602. The data record has values of features. For example, the record with ID “1” has value “0.3” for X1, “0.7” for X2, . . . , and “0.2” for Xn, the record with ID “2” has value “0.5” for X1, “0.2” for X2, . . . , and “0.5” for Xn, etc.

In step 420, the computer determines a feature representative data set from the original data set. The feature representative data set includes same number of feature representative data records with the original data set, and each feature representative data record has values of a second number of feature representatives (for example, m feature representatives, in which m is an integer). According to an embodiment of the present invention, the feature representatives may be obtained by training an autoencoder neutral network with values of the first number (n) of features as inputs. According to an embodiment of the present invention, the second number m is smaller than the first number n.

According to embodiments of the present invention, an autoencoder neural network is used to reduce the dimension of features of the data set into a smaller number of representatives. An autoencoder is a type of artificial neural network used to learn efficient data codings in an unsupervised manner. The aim of an autoencoder is to learn a representation (encoding) for a set of data, typically for dimensionality reduction, by training the network to ignore signal “noise”. An autoencoder learns to copy its input to its output. It has an internal (hidden) layer that describes a representation used to represent the input, and it is constituted by two main parts: an encoder that maps the input into the representation, and a decoder that maps the representation to a reconstruction of the original input. The output layer has the same number of nodes as the input layer, with the purpose of reconstructing its inputs (minimizing the difference between the input and the output).

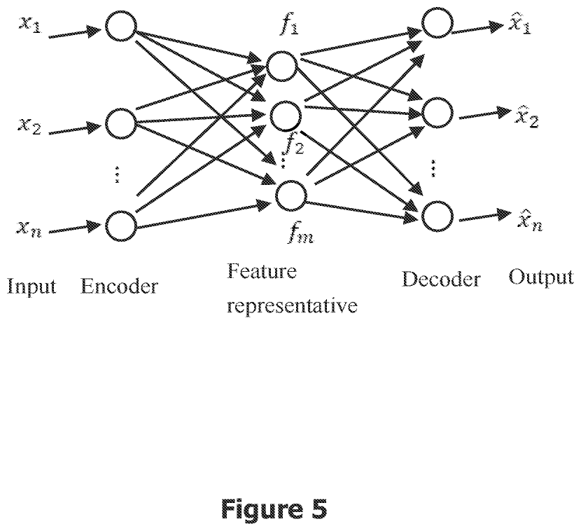

FIG. 5 is an example of a typical autoencoder neural network which may be used to implement the method according to embodiments of the present invention. The input values x₁, . . . , xₙ, are values of one record in the original data set. The encoder layer encodes the input values into m(m<n) values f₁, . . . , fₘ which are values of m feature representatives F1, F2, . . . , Fm, respectively. Then the feature representative values are decoded by decoder layer to another n output values \hat{x}₁, . . . , \hat{x}2 which are the prediction of x₁, . . . , xₙ, respectively. By minimizing the difference between the input values x₁, . . . , xₙ, and the output values \hat{x}₁, . . . , \hat{x}ₙ of the autoencoder, the n features of the original data set would be reduced to m feature representatives.

FIG. 6B depicts a diagram illustrating an example of a feature representative data set in accordance with an illustrative embodiment of the present invention. Feature representative data set 603 includes record ID 605 and feature representatives 608. Record ID 605 corresponds to record ID 604 in the original data set. Feature representatives 608 may be obtained from features 606 of original data set 602 by using an autoencoder neutral network. Each column in the table is one feature representative, such as F1, F2, F3, . . . Fm. Here m is an integer smaller than n. Record ID 605 may represent a data record in the feature representative data set 603 and the data record has values of feature representatives. For example, the record with ID “1” has value “0.23” for F1, “0.51” for F2, . . . , and “0.36” for Fm, the record with ID “2” has value “0.31” for F1, “0.52” for F2, . . . , and “0.43” for Fm, etc.

Moving back to FIG. 4, in step 430, the computer segments the data records of the feature representative data set into two or more clusters based on the values of the second number of feature representatives. According to an embodiment of the present invention, the segmenting may be performed by using clustering techniques such as K-mean cluster. A variable of cluster label would be created, and each data record would have a cluster label.

FIG. 6C depicts a diagram illustrating an example of a feature representative data set in accordance with an illustrative embodiment of the present invention. Feature representative data set 603 includes record ID 605, feature representatives 608 and cluster label 609. Feature representatives 608 and record ID 605 are same with those shown in FIG. 6B. Cluster label 609 may represent the clustering result for each data record obtained in step 430. In the example of FIG. 6C, the data records are segmented into two clusters, Cluster-1 and Cluster-2.

In step 440, the computer partitions the feature representative data records in the two or more clusters to form a specified number of feature representative data subsets, that is, a data partition of the feature representative data set. According to an embodiment of the present invention, the feature representation data records may be partitioned into data subset by a stratified data sampling with the cluster label variable as stratified variable.

Stratified sampling is a type of sampling method in which the total population is divided into smaller groups or strata to complete the sampling process. The strata should define a partition of the population. The strata is formed based on some common characteristics in the population data. If the groups are of different sizes, the number of items selected from each group may be proportional to the number of items in that group.

FIG. 6D depicts a diagram illustrating an example of a data partition of the feature representative data set in accordance with an illustrative embodiment of the present invention. Besides record ID 605, feature representatives 608 and cluster label 609, feature representative data set 603 further includes partition label 610. Partition label 610 may represent the partitioning result for each data record obtained in step 440. In the example of FIG. 6D, the partition label includes training and testing, indicating the corresponding data record belongs to training data subset or testing data subset.

After partitioning the feature representative data set into the specified number of representative data subsets in step 440, the computer obtains a data partition of the original data set based on the data partition of the feature representative data set in step 450. According to an embodiment of the present invention, a partition variable may be obtained for each record in the feature representative data set in step 440, and the partition variable may be merged to the original data set to identify a partition of the original data set.

FIG. 6E depicts a diagram illustrating an example of a data partition of the original data set in accordance with an illustrative embodiment, in which original data set 602 includes record ID 604, features 606 and partition label 610.

In this example, data partition of the original data set includes training data subset and testing data subset. However, it should be noted that data partition is meant as an example only and not as a limitation of different illustrative embodiments. In other words, data partition may include more or fewer data subsets than shown. Data subsets may include three data subsets, for example, a training data subset, a validation data subset, and a testing data subset. In addition, it should be noted that training data subset includes a specified variable percentage of the original data set, and testing data subset includes another specified variable percentage of the original data set. For example, in the case of three data subsets, each data subset in the specified number of data subsets includes a specified percentage of the data set, such as, for example, 60% of the data set is included in the training data subset, 20% of the data set is included in the validation data subset, and 20% of the data set is included in the testing data subset.

With the process illustrated in FIG. 4, illustrative embodiments provide data partitioning that ensures feature distribution of each data subset of a particular data partition of the original data set is similar (i.e., as close as possible) to that of the original data set (i.e., to provide variable distribution consistency). Furthermore, illustrative embodiments use autoencoder neural network to reduce the size of features of the data set, increasing the quality of the partition.

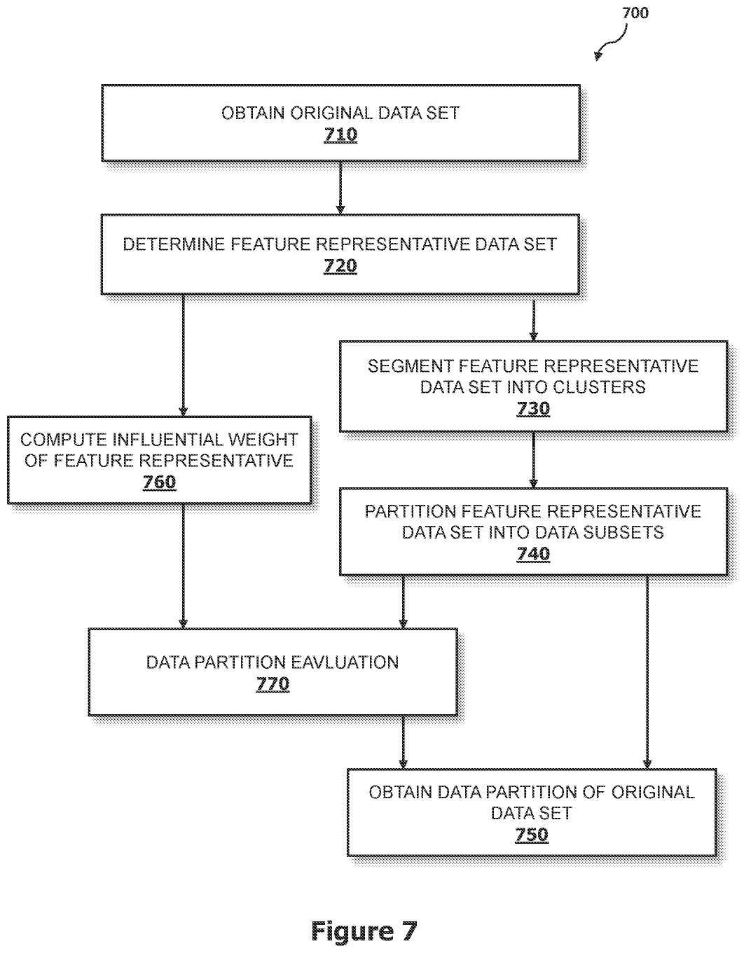

With reference now to FIG. 7, a flowchart illustrating a process for evaluating data partition quality is shown in accordance with an illustrative embodiment. The process shown in FIG. 7 may be implemented in a computer, such as, for example, computer system/server 12 in FIG. 1. Please note that the steps 710, 720, 730 and 740 are similar to the steps 410, 420, 430 and 440 described above with reference to FIG. 4 and the detailed description of those steps would be omitted.

After the computer determines a feature representative data set from the original data set in step 720 with an autoencoder neutral network, the computer may compute influential weights of the feature representatives based on the autoencoder neural network and the feature representatives determined in step 720.

According to an embodiment of the present invention, for each feature representative Fi, its influential weight may be computed as below. First, the value of the feature representative Fi would be changed randomly while the values of other feature representatives are fixed. The accuracy of prediction of the original data values is then determined. Based on accuracy, the influential weight for each feature representative can be obtained, denoted as w₁, . . . , wₘ.

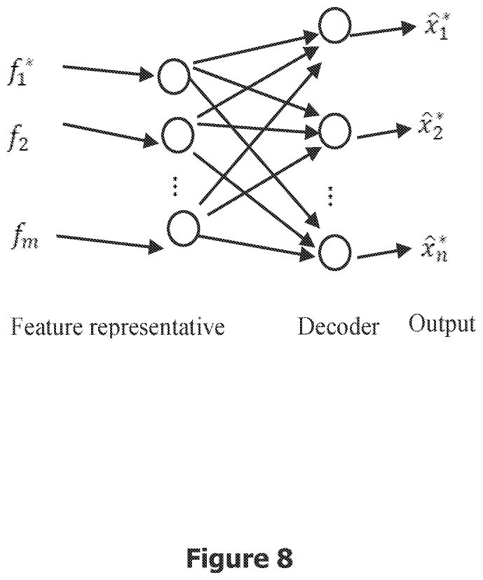

FIG. 8 depicts a diagram illustrating an example for computing influential weight using autoencoder neural network, where f₁*, f₂, . . . , fₘ is a data record from the feature representative data set with one value f₁ being changed to f₁*, and \hat{x}₁*, . . . \hat{x}ₙ* are predictions of x₁, . . . , xₙ, respectively.

Use the table of feature representative data set shown in FIG. 6C as an example. For feature representative F₁, the value f₁ would be randomly changed while the values f₂, . . . , fₘ are fixed and prediction \hat{x}₁*, . . . , \hat{x}₁* of x₁, . . . , xₙ, would be obtained with the autoencoder neutral network. The accuracy of prediction \hat{x}₁*, . . . , \hat{x}ₙ8 of x₁, . . . , xₙ, is checked and an influential weight w₁ for feature representative F₁ can be obtained. With this process, the influential weight w₁, . . . , wₘ for each feature representative F₁, . . . , Fₘ would be obtained.

In step 770, with the influential weight computed in step 760, a data partition quality evaluation may be performed for the data partition of feature representative data set obtained in step 740 to evaluate feature distribution similarity.

For each feature representative Fi, statistical test such as two sample Kolmogorov-Smirnov (KS) test, is performed to test if the distribution of Fi in each subset is similar to that of Fi in the original data set The average of the test significant values from all subsets will be used for the distribution similarity measure of the feature representative Fi. Denote the distribution similarity measure for each feature representative Fi as sᵢ. The quality of data partition is the weighted average of sᵢ with weight wᵢ, i.e.,

q=Σᵢ₌₀^{m}wᵢ*sᵢ

wherein q is the quality of the data partition, s, is the distribution similarity of the feature representative Fᵢ, and wᵢ is the influential weight of the feature representative Fᵢ.

Feature distribution similarity measuring may utilize a statistical test, such as, for example, a two sample Kolmogorov-Smirnov test, to test whether the distribution of the feature representatives from each data subset is similar to that in the feature representative data set. The two sample Kolmogorov-Smirnov test is a general nonparametric test for comparing two samples. The two sample Kolmogorov-Smirnov test is sensitive to differences in both location and shape of the empirical cumulative distribution functions of the two samples. The two sample Kolmogorov-Smirnov test may be used to test whether two samples come from the same distribution. Based on the significant p-values of the statistical test, illustrative embodiments compute a distribution similarity measure between the data set and each subset of data of the partition. A p-value is the probability that a variate would assume a value greater than or equal to the observed value strictly by chance.

After partitioning the representative data set into the specified number of representative data subsets in step 740, the computer obtains a data partition of the original data set based on the partition of the representative data set in step 750. According to an embodiment of the present invention, a partition variable may be obtained for each record in the representative data set in step 740, and the partition variable may be merged to the original data set to identify a partition of the original data set. And the data partition evaluation result obtained in step 770 may be provided together with the partition of the original data set obtained in step 750.

Thus, illustrative embodiments of the present invention provide a computer-implemented method, computer system, and computer program product for performing data partition, with features distribution of each partition data subset being similar to a original data set. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
obtaining, by one or more processing units, an original data set including a plurality of data records, each data record in the original data set having values of a first number of features;
determining, by one or more processing units, a feature representative data set having a plurality of feature representative data records, each feature representative data record having values of a second number of feature representatives, wherein the second number of feature representatives are obtained by training an autoencoder neutral network with values of the first number of features as inputs, and wherein the second number is smaller than the first number;
segmenting, by one or more processing units, the plurality of feature representative data records into two or more clusters based on the values of the second number of feature representatives; and
partitioning, by one or more processing units, the feature representative data records in the two or more clusters to form a predefined number of feature representative data subsets.

2. The computer-implemented method of claim 1, further comprising:
obtaining, by one or more processing units, data subsets of the original data set according to the predefined number of feature representative data subsets.

3. The computer-implemented method of claim 1, further comprising:
for a feature representative of the second number of feature representatives, computing, by one or more processing units, an influential weight of the feature representative.

4. The computer-implemented method of claim 3, wherein the influential weight of the feature representative is computed by:
changing the value of the feature representative and fixing values of other feature representatives in one of the plurality of feature representative data records;
determining an accuracy of prediction of the autoencoder neural network; and
obtaining the influential weight of the feature representative based on the accuracy.

5. The computer-implemented method of claim 3, further comprising:
evaluating, by one or more processing units, a quality of data partition based on the influential weights and the feature representative data subsets.

6. The computer-implemented method of claim 5, wherein evaluating, by one or more processing units, a quality of data partition based on the influential weights and the partition of the feature representative data set further comprising:
for each feature representative Fi, measuring a distribution similarity si of the feature representative Fi between the respective feature representative data subsets and the feature representative data set; and
obtaining the quality of the data partition based on the distribution similarity si and the influential weight wi of the feature representative Fi.

7. The computer-implemented method of claim 6, wherein the quality of the data partition is obtained with the following formula:
$$q = {\sum }_{i = 0}^{m} {w}_{i} * {s}_{i}$$
wherein q is the quality of the data partition, sᵢ is the distribution similarity and wᵢ is the influential weight of the feature representative Fᵢ.

8. The computer-implemented method of claim 1, wherein partitioning, by one or more processing units, the feature representative data records in the two or more clusters to form a third number of feature representative data subsets comprising:
randomly sampling, by one or more processing units, the feature representative data records in each cluster of the two or more clusters to form the third number of feature representative data subsets.

9. The computer-implemented method of claim 2, wherein the features from the data subsets and the original data set are one of categorical variables and continuous variables.

10. The computer-implemented method of claim 1, wherein the original data set is related to one of the following domains: an insurance domain, a banking domain, a healthcare domain, a financial domain, an entertainment domain, and a business domain.

11. A computer program product comprising:
one or more computer readable storage media and program instructions stored on the one or more computer readable storage media, the program instructions comprising:
program instructions to, obtaining an original data set including a plurality of data records, each data record in the original data set having values of a first number of features;
program instructions to determine a feature representative data set having a plurality of feature representative data records, each feature representative data record having values of a second number of feature representatives, wherein the second number of feature representatives are obtained by training an autoencoder neutral network with values of the first number of features as inputs, and wherein the second number is smaller than the first number;
program instructions to segment the plurality of feature representative data records into two or more clusters based on the values of the second number of feature representatives; and
program instructions to partition the feature representative data records in the two or more clusters to form a predefined number of feature representative data subsets.

12. The computer program product of claim 11, wherein the program instructions stored on the one or more computer readable storage media further comprise:
program instructions to obtain a third number of data subsets of the original data set according to the predefined number of feature representative data subsets.

13. The computer program product of claim 11, wherein the actions further comprise:
for a feature representative of the second number of feature representatives, program instructions to compute an influential weight of the feature representative.

14. The computer program product of claim 13, wherein the influential weight of the feature representative is computed by:
program instructions to change the value of the feature representative and fixing the values of other feature representatives in a feature representative data record;
program instructions to determine an accuracy of prediction of the autoencoder neural network; and
program instructions to obtain the influential weight of the feature representative based on the accuracy.

15. A computer system for comprising:
one or more computer processors;
one or more computer readable storage media; and
program instructions stored on the one or more computer readable storage media for execution by at least one of the one or more computer processors, the program instructions comprising:
program instructions to obtain an original data set including a plurality of data records, each data record in the original data set having values of a first number of features;
program instructions to determine a feature representative data set having a plurality of feature representative data records, each feature representative data record having values of a second number of feature representatives, wherein the second number of feature representatives are obtained by training an autoencoder neutral network with values of the first number of features as inputs, and wherein the second number is smaller than the first number;
program instructions to segment the plurality of feature representative data records into two or more clusters based on the values of the second number of feature representatives; and
program instructions to partition the feature representative data records in the two or more clusters to form a predefined number of feature representative data subsets.

16. The computer system of claim 15, wherein the actions further comprise:
program instructions to obtain a third number of data subsets of the original data set according to the predefined number of feature representative data subsets.

17. The computer system of claim 15, wherein the actions further comprise:
for a feature representative of the second number of feature representatives, program instructions to compute an influential weight of the feature representative.

18. The computer system of claim 17, wherein the influential weight of the feature representative is computed by:
program instructions to change the value of the feature representative and fixing values of other feature representatives in one of the plurality of feature representative data records;
program instructions to determine an accuracy of prediction of the autoencoder neural network; and
program instructions to obtain the influential weight of the feature representative based on the accuracy.

19. The computer system of claim 17, wherein the actions further comprise:
program instructions to evaluate a quality of data partition based on the influential weights and the feature representative data subsets.

20. The computer system of claim 19, wherein evaluating a quality of data partition based on the influential weights and the partition of the feature representative data set further comprising:
for each feature representative Fi, program instructions to measure a distribution similarity si of the feature representative Fi between the respective feature representative data subsets and the feature representative data set; and
program instructions to obtain the quality of the data partition based on the distribution similarity si and the influential weight wi of the feature representative Fi.
